(19) United States
(12) Patent Application Publication
(10) Pub. No.: US 2018/0300817 A1
(43) Pub. Date: Oct. 18, 2018

(54) METHOD FOR MANAGING ENVIRONMENTAL INSURANCE

(71) Applicant: John Christopher Bunbury, Leland, MI (US)

(72) Inventor: John Christopher Bunbury, Leland, MI (US)

(21) Appl. No.: 15/952,313

(22) Filed: Apr. 13, 2018

Related U.S. Application Data
(60) Provisional application No. 62/485,913, filed on Apr. 15, 2017.

(51) Int. Cl. G06Q 40/08; G06Q 10/06

(52) U.S. Cl. CPC G06Q 40/08; G06Q 10/0635

(57) ABSTRACT

A method for identifying and managing the appropriate environmental insurance plan that is specifically customized for the HNW insured's. The method provides an accurate and customized approach for assessing the risk tolerance of the HNW insured's for their environmental exposure. The method involves determining the amount of environmental risk, in the form of environmental exposures and environmental liability, the HNW can fiscally tolerate for its resources. Specifically, this method involves providing the HNW with the information necessary to determine whether it makes fiscal sense to transfer its environmental liabilities to an environmental/pollution risk transfer model, as opposed to waiting until an environmental loss actually occurs.

### PRIORITY CLAIM

This patent application is a Non-Provisional patent application and claims priority under 35 U.S.C. 119(e) to U.S. Provisional Patent Application Ser. No. 62/485,913, titled “SYSTEM AND METHOD FOR MANAGING ENVIRONMENTAL INSURANCE,” filed Apr. 15, 2017. The entire disclosure of the aforementioned patent application is incorporated by reference as if fully stated herein.

### FIELD

This patent application relates to a method for managing environmental insurance. More specifically, the patent application relates to a method for managing pollution insurance for High Net Worth Individuals (HNWI) and the High Net Worth insured's.

### BACKGROUND

Since most businesses are impacted by environmental exposures, such as mold, fungi, flood, windstorms, pollution, fire, earthquakes, oil spills, contamination, waste (hazardous and non-hazardous), and harmful gases, environmental insurance provides an approach for reducing or eliminating the negative impact of uncertain future environmental liabilities. Specifically, pollution insurance has been differentiated from other forms of insurance as it can often be expected or foreseen. Therefore, it is not always considered an accident or an occurrence under a general liability policy. Typically, General Liability policies contain and absolute or total pollution exclusion. Every business is impacted by environmental exposures.

Pollution insurance coverage can be divided into first-party coverage and third-party coverage. First-party coverage typically provides funding to individuals or businesses that have an environmental accident, such as a spill or contamination. Third-party coverage typically protects individuals and businesses due to a release of a pollutant from a facility owned or operated by the insured that adversely affects others or from an environmental liability created by a contractor.

Even though methods currently exist for managing pollution insurance for insured's, these methods are not specifically customized for High Net Worth Individuals (HNWI) and the High Net Worth (HNW) insured's and the environmental exposures created by their resources. HNW insured's refer to a small percentage of the population having a net worth of at least $10,000,000 that are uniquely impacted by a variety of environmental exposures, through their aircrafts, yachts, cars, real estate, and other business assets.

At this time, the environmental insurance options for HNW insured's essentially just involve self-insurance. The problem with self-insurance for HNW insured's is that these practices typically involve waiting until some environmental loss actually occurs from their resources. As a result, there can be significant costs, such as legal fees, cleanup costs, building damage, disposal costs, claim management costs, and liability to the HNW insured's associated with any environmental loss or harmful exposure stemming from the HNW insured's resources.

Consequently, there is a need for a method that can identify and manage the appropriate environmental insurance plan that is specifically customized for the HNW insured's. In doing so, the method must provide an accurate and customized approach for assessing the risk tolerance of the HNW insured's for their potential environmental exposure.

### SUMMARY

What is provided is a method that can identify and manage the appropriate environmental insurance plan that is specifically customized for the HNW insured's. In doing so, the method provides an accurate and customized approach for assessing the risk tolerance of the HNW insured's for their environmental exposure.

In exemplary embodiments, the method for identifying and analyzing an environmental insurance plan that is specifically customized for the HNW involves educating the HNW of the potential environmental exposures and liability concerning its resources in order to identify the potential environmental risks and understand the value that pollution liability insurance may add to protecting resources of the HNW. Next, this method involves determining the amount of environmental risk, in the form of environmental exposures and environmental liability, the HNW can fiscally tolerate for its resources.

Further, this method involves providing the HNW with the information necessary to determine whether it makes fiscal sense to transfer its environmental liabilities to an environmental/pollution risk transfer model, as opposed to waiting until an environmental loss actually occurs. Then, information about the HNW, its customers, products, and environmental resources is analyzed in order to provide targeted recommendations to the HNW. Lastly, an environmental insurance application is prepared for the HNW, which is eligible for submission to an insurance broker, agent, or company.

In exemplary embodiments, the method for developing, implementing, and managing an environmental insurance strategy for the HNW comprises identifying the initial environmental footprint specific for the HNW based on acceptable and unacceptable environmental exposures and initiating an environmental efficiency evaluation to identify direct and indirect environmental issues impacting the HNW. The environmental efficiency evaluation comprises identifying and analyzing the following information regarding the HNW: (1) who the HNW is conducting the business with; (2) what is occurring within the HNW's business and resources; (3) type of goods and/or services leaving the HNW's business and resources; and (4) neighboring businesses and individuals to the HNW.

Once the environmental efficiency evaluation has been conducted for the HNW, the remaining steps in this exemplary method involve compiling the information gathered from the environmental efficiency evaluation into a categorized format, providing professional competitive intelligence to the environmental efficiency compilation, and implementing a proposed environmental Management Strategy (eMS) for the HNW's business and resources.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is a flow chart of an exemplary method for identifying and analyzing an environmental insurance plan that is specifically customized for the HNW; and

FIG. 2 is a flow chart of an exemplary method for developing, implementing, and managing an environmental insurance strategy for the HNW.

### DETAILED DESCRIPTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and components have not been described in detail so as not to obscure the examples defined by the claimed subject matter.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term “system” may, depending at least in part upon the particular context, be understood to include any method, process, apparatus, and/or other patentable subject matter that implements the subject matter disclosed herein. The subject matter described herein may be implemented in software, in combination with hardware and/or firmware. For example, the subject matter described herein may be implemented in software executed by a hardware processor.

Through this specification, the term “High Net Worth,” “HNWI,” or “HNW” refers to individual(s) or entities having resources such as, but not limited to homes, automobiles, boats, aircrafts, businesses, resorts, farms/ranches, oil/gas well, brownfields, and real estate development, and holding financial assets of at least about $10,000,000. The term “insureds” or “insured's” refers to an individual, group, or organization whose life or property is covered by an insurance policy.

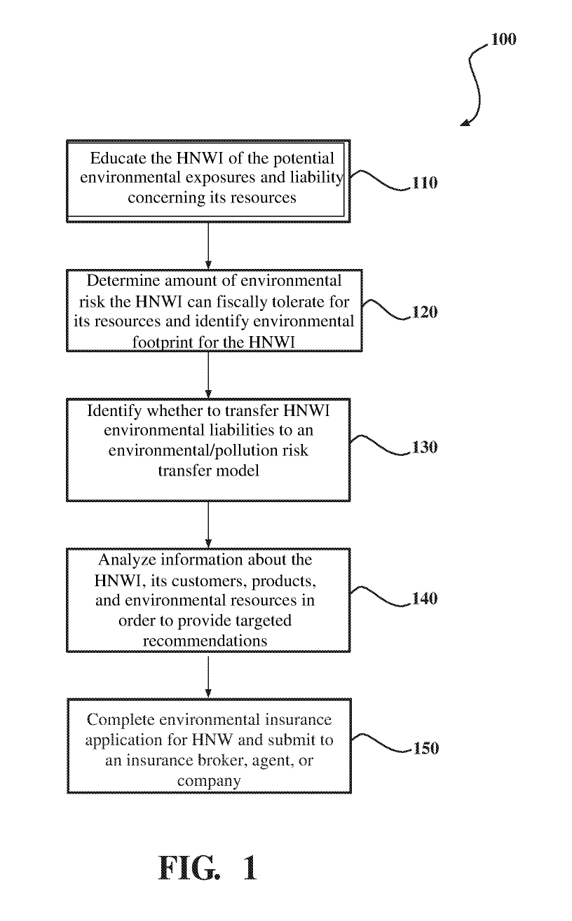

Referring to FIG. 1, FIG. 1 shows a flow chart of an exemplary method 100 for identifying and analyzing an environmental insurance plan that is specifically customized for the HNW. In this exemplary method 100, the first step 110 involves educating the HNW of the potential environmental exposures and liability concerning its resources. Specifically, this involves precisely defining what constitutes a “pollutant” for each of the HNW insured's unique resources and coverage requirements. As a result, the HNW insured's can precisely identify the potential environmental risks and understand the value pollution liability insurance may add to protecting their resources. In some examples, a “pollutant” may constitute a material, substance, product or the like that is introduced into an environment other than for its intended use.

Examples of education resources include, but are not limited to environmental Risk Assessment (“eRA”) for HNW insured's, access to online platforms, such www.estrategist.com, for managing the environmental management strategy for HNW insured's, webinars, live seminars, and other educational resources.

Block 120 refers to determining the amount of environmental risk, in the form of environmental exposures and environmental liability, the HNW can fiscally tolerate for its resources. Specifically, this looks to the environmental footprint for the HNW and involves an examination of potential acceptable and unacceptable environmental exposures for the HNW such as, but not limited to mold; vandalism; storage, use, and/or maintenance of aircraft, automobile, and watercraft; real estate with historically environmental problems; new construction and remodeling; pollution from neighboring properties; privately owned businesses with environmental exposures; vendors such as contractors (HVAC, electrical, plumbing, painting, septic); domestic help; landscapers/maintenance; pool cleaning/maintenance; caterers; boat captains; aircraft pilots; storm water runoff; vapor intrusion; leaks from elevator hydraulic fluid storage tanks; impacting sensitive areas, such as wetlands or endangered species; government reporting requirements; natural resource damages; real estate tenants using or storing environmentally sensitive materials, chemicals, waste; sick building syndrome; above ground or underground storage tanks; adverse reactions and interactions of chemical compounds that accidentally commingle during a fire; farm/garden/lawn fertilizers, herbicides, pesticides; easements (utility, oil, gas . . . ) that cross your property which may leak or spill hazardous materials; LEEDS; fuel tanks used for backup power generators; asbestos; lead; and Brownfields.

A HNW insurance program is one of several examples for HNW insured's to finance an environmental liability. Other examples include self-insurance, bond, or letter of credit. Currently, self-insurance is the most common approach for financing an environmental liability based on a lack of proper education and resources.

Further, Block 120 involves an examination for the HNW of its potential environmental liability, such as, but not limited to legal defenses; environmental impairment liability; transportation pollution; contractors pollution liability; 1^{st} and 3^{rd} party bodily injury and property damage, such as real property, personal property, and personal property of others; 1^{st} and 3^{rd} party business income; emergency response; lead; mold; exterior finish & insulating systems; reputational risk; natural resource damage; non-owned disposal sites, merger acquisition and pollution protection coverage; property transfer coverage; surety; excess liability or umbrella coverage; underground and above ground storage tanks; excess of indemnity; and cost cap coverage. In addition, secured creditor coverage/lender liability protects specific groups of HNW insured's, such as banks/lenders, in situations where they may need to foreclose due to an environmental loss.

Since the potential risk of environmental exposure and liability is high for HNW insured's, it is particularly important that HNW insured's have a financial assurance strategy and that the strategy be in line with the HNW insured's environmental insurance plan. This may be accomplished by assessing and specifically taking into account the risk tolerance and risk appetite of the HNW insured's on an individual basis.

Block 130 involves providing the HNW with the information necessary to allow the HNW to determine whether it makes fiscal sense to transfer its environmental liabilities to an environmental/pollution risk transfer model, as opposed to waiting until environmental loss actually occurs. Based on the risk tolerance of the HNW and the resources provided to the HNW, an informed decision may be made regarding whether to spend a relatively small cost to transfer environmental liabilities or to wait until an environmental loss occurs and pay the full amount out of pocket. Even though environmental liabilities typically don't occur as frequently for the HNW, they tend to be more severe and damaging. Thus, an alternative to self-insurance for the HNW is provided. Each HNW clearly defines its risk appetite in order to help guide its resource allocation in anticipation of a potential environmental loss.

Block 140 involves defining, gathering, analyzing, and evaluating intelligence about the HNW, its products, its customers, competitors, and any aspect of the environment needed to establish specific values and provide recommendations to the HNW. Specifically, the information and data collected in block 110, block 120, and block 130 are merged together to provide specific recommendations customized to each HNW. In some examples, an environmental efficiency evaluation is conducted in order to best identify the various direct and indirect environmental issues impacting the HNW insured and its business. By having a defined starting point, it becomes much easier for the HNW insured's to measure their sustainable progress and benefits in order to drive future growth and profits. The environmental efficiency evaluation can take on various forms, such as, but not limited to a questionnaire with a categorized format.

If the HNW desires to transfer the environmental exposures for its resources, the HNW completes an environmental insurance application and submits it to an insurance broker, agent, carrier, company, or the like utilizing the method 100 disclosed herein, as shown in block 150. Various personal and environmental information about the HNW and the location at issue is collected through the environmental insurance application.

The insurance broker, agent, or company then identifies and closes any coverage gaps for the HNW insured with the appropriate type of environmental insurance protection, as compared with general liability coverage policies having an “Absolute” or Total” pollution exclusion. The environmental insurance protection should be customized for the HNW insured's environmental concerns and risks.

Examples of some of the types of coverage for the HNW insured's provided in the method 100 disclosed herein are environmental impairment liability, property transfer coverage, transportation pollution liability, underground storage tanks, aviation pollution liability, contractors pollution liability, marine pollution liability, and emergency response costs. In some embodiments, environmental impairment liability coverage is for those who own, operate, lease, or have any other insurable interest in real property and the operations. In these embodiments, coverage may be written by addressing unknown preexisting conditions or new conditions. Coverage may include 3^{rd} party bodily injury, property damage, business interruption, and extra expense; cleanup costs; legal defense expenses; non-owned disposal sites; transportation response; and emergency response.

In some embodiments, property transfer coverage protects the new owner or any party with an insurable interest against unknown environmental conditions, which may be discovered during the duration of the policy and not caused by the new owner. In these embodiments, the property transfer coverage can also protect the HNW insured should a third party have contamination that migrates onto an insured site. This is of particular importance since federal laws and regulations specify that property owners are ultimately responsible for the environmental condition of their property, regardless of who/what created the environmental liability.

In some embodiments, the HNW insured's may protect themselves from vendors they hire using contractors pollution liability insurance or owner controlled contractors pollution liability insurance. Contractors' pollution liability protects the insured vendor/contractor should the vendor/contractor cause an environmental condition while performing services for the HNW insured. Contractors' pollution liability protects the HNW insured for covered operations performed by or on behalf of the HNW insured. Coverage can be on a job-specific basis or on a broad basis to cover all the work to be performed by the vendor/contractor. Policies for this type of coverage may encompass transportation pollution liability, mold, lead, asbestos, off-site disposal coverage, emergency response costs, and the like.

In other embodiments, the HNW insured's may use owner controlled contractors pollution liability to cover the variety of vendors/contractors that perform services, such as domestic help, landscaping, boat and aircraft operation, and the like. As the first named insured, the HNW insured is the only person who can make changes to the policy.

In some embodiments, transportation pollution liability covers pollution losses arising from spills or other releases from transported cargo. This provides coverage during the loading, unloading, and transportation for a spill, release, or sudden upset of transported cargo in conveyance for road, rail, water or air.

In some embodiments, owners and operators of underground storage tank systems are required to financially handle a release from an underground storage tank. The requirements for the HNW insured includes paying funds for corrective action and third party bodily injury and property damage from regulated underground system releases. Federal laws specifically require proof of financial insurance to handle releases from regulated storage tank systems.

In some embodiments, aviation insurance policies cover pollution liabilities for an aircraft in motion/operation, but not while parked or idle. This type of coverage can protect an HNW insured aircraft owner from potential liability associated with indemnification clauses.

In some embodiments, marine pollution liability covers for pollution losses for fluids necessary for the operation of a watercraft owned or operated by the HNW insured for a covered cause of loss. This type of coverage can protect HNW insured's from pollution losses not commonly covered by marine/yacht insurance policies.

In some embodiments, the emergency responses costs for the HNW, such as those to address clean up, investigation, transportation, disposal, third party damage, third party bodily injury costs, and the like.

Block 150 involves educating the HNW insured's on the benefits, coverage, and differences between the various environmental insurance policy options in order to identify the best investment option for the HNW insured's. The method 100 described herein may be bundled into a single product or a variety of products. In some examples, a few pollution products may be bundled together by using an excess policy over an underlying environmental coverage, such as contractors pollution liability, that may be readily available through a web-based format to the HNW insured's. The product(s) may be available to the HNW insured's through independent insurance agents, insurance companies/carrier, Internet sales, and the like.

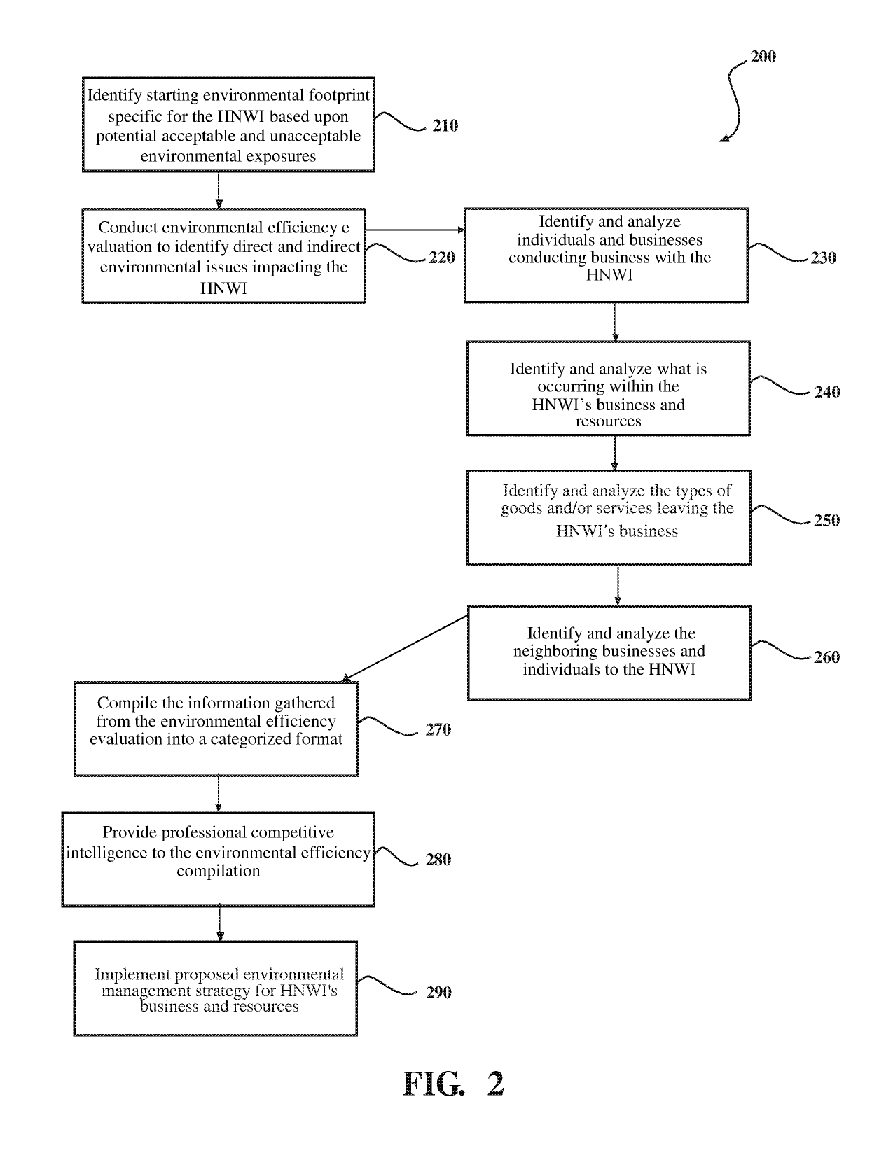

Referring to FIG. 2, FIG. 2 shows a flow chart of an exemplary method 200 for developing, implementing, and managing an environmental insurance strategy for the HNW. Block 210 involves identifying the starting environmental footprint specific for the HNW based upon an examination of potential acceptable and unacceptable environmental exposures such as, but not limited to mold; vandalism; storage, use, and/or maintenance of aircraft, automobile, and watercraft; real estate with historically environmental problems; new construction and remodeling; pollution from neighboring properties; privately owned businesses with environmental exposures; vendors such as contractors (HVAC, electrical, plumbing, painting, septic); domestic help; landscapers/maintenance; pool cleaning/maintenance; caterers; boat captains; aircraft pilots; storm water runoff; vapor intrusion; leaks from elevator hydraulic fluid storage tanks; impacting sensitive areas, such as wetlands or endangered species; government reporting requirements; natural resource damages; real estate tenants using or storing environmentally sensitive materials, chemicals, waste; sick building syndrome; above ground or underground storage tanks; adverse reactions and interactions of chemical compounds that accidentally commingle during a fire; farm/garden/lawn fertilizers, herbicides, pesticides; easements (utility, oil, gas . . . ) that cross your property which may leak or spill hazardous materials; LEEDS; fuel tanks used for backup power generators; asbestos; lead; and Brownfields.

Next, block 220 refers to the initiation of an environmental efficiency evaluation to best identify the various direct and indirect environmental issues impacting the HNW insured and its business. The environmental efficiency evaluation can take on various forms, such as, but not limited to a questionnaire with a categorized format. Examples of the specific categories of data that may be collected through the questionnaire include information about the HNW's business, property, transportation, watercraft, aircraft, current risk transfer/insurance policies, regulatory compliance requirements, liquid effluents, above ground storage tanks, underground storage tanks, solid waste management, and hazardous waste management.

The first part of the environmental efficiency evaluation focuses on identifying and analyzing who the HNW insured is conducting business with and what types of things are entering the HNW insured's business, according to block 230. In some examples, this involves gathering information regarding the current interactions of customers, suppliers, business vendors, sales people, tenants, manufacturers, contractors, and/or students with the HNW's business and resources. This step also refers to identifying the HNW current strategies for dealing with any environmental loss/impact that may occur from the individuals that conduct business with the HNW. In doing so, it is important to identify whether a client and/or vendor can have a negative environmental impact on the HNW's business and whether the client and/or vendor can create direct and indirect environmental liabilities.

Examples of instances of environmental loss include the presence of Legionnaire disease in a pool/hot tub owned by the HNW insured, severe damage to a protected coral reef by a yacht owned by the HNW insured, and chemical contamination of soil on real estate property to be used for development that was previously determined to be “clean.”

Next, block 240 involves an identification and analysis of what is occurring within the HNW's business. Examples of information collected here include the ways in which the HNW stores, handles, and treats raw materials, supplies, and waste. Additional information that is collected and analyzed involves a determination of whether the HNW and its respective business are subject to any environmental laws or regulations due to its resources.

Block 250 involves an identification and analysis (from an environmental perspective) of the information concerning the types of goods and/or services leaving the HNW's business or resources. Examples of the goods and services include finished products, equipment, recyclables, waste materials, and vendor services. Since the HNW are responsible for their own manifested waste from cradle to grave according to the Comprehensive Environmental Response, Compensation, and Liability Act (CERCLA), reductions in waste stream are correlated with reductions in future liabilities.

Next, an identification and analysis of the neighboring business and individuals to the HNW is conducted, according to block 260. Even if the HNW is executing an environmental management strategy with regard to its resources, the HNW may still experience an indirect environmental impact from one of its neighbors. As such, it is important to identify the neighbors of the HNW and to understand the potential environmental liabilities they may present.

As shown in block 270, an environmental strategist specific for the HNW compiles the information gathered from the environmental efficiency evaluation into a categorized format for review and analysis by an environmental strategy team. In some embodiments, the development of the HNW environmental strategy involves contributions from a team comprising a plurality of individuals, such as key employees, legal counsel, risk managers/insurance agents, accountants, financial institution representatives, realtors, and environmental services providers.

Next, the individuals in the environmental strategy team each provide their professional competitive intelligence to the environmental efficiency compilation in order to prioritize and budget for the specific strategy proposed by the team, according to block 280. The environmental management strategy proposed by the team should be seamlessly blended into the HNW's business and resources.

In block 290, the HNW implements the proposed environmental management strategy for its business and resources. The environmental management strategy provides a customized evolving, continual improvement strategy that allows the HNW to be environmentally transparent for its business and resources.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

It will, of course, be understood that, although particular embodiments have just been described, the claimed subject matter is not limited in scope to a particular embodiment or implementation. Likewise, an embodiment may be implemented in any combination of systems, methods, or products made by a process, for example.

In the preceding description, various aspects of claimed subject have been described. For purposes of explanation, specific numbers, systems, and/or configurations were set forth to provide a thorough understanding of claimed subject matter. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that claims are intended to cover all such modifications or changes as fall within the true spirit of claimed subject matter.

1. A method of managing environmental insurance specifically for a High Net Worth Individual (HNWI) based on the HNWI's resources, the method comprising:
determining a pollutant for each of the HNWI's resources in order to identify potential environmental risks associated with the HNWI's unique resources;
analyzing collected data and information regarding the HNWI and the HNWI's resources to identify environmental issues impacting the HNWI and the HNWI's resources;
calculating the amount of environmental risk the HNWI can fiscally tolerate for the HNWI's resources based on the HNWI's environmental exposures and associated environmental liability;
identifying the HNWI's risk return goals and objectives to determine likelihood of HNWI self-insuring;
capturing information about the HNWI and the HNWI's resources via an environmental insurance application; and
determining the appropriate type of environmental insurance coverage specifically for the HNWI based on the environmental risks surrounding the HNWI's resources.

2. The method of claim 2, wherein the HNWI's environmental liability comprises legal defenses, environmental impairment liability, transportation pollution, contractors pollution liability, 1^{st} and 3^{rd} party bodily injury and property damage, 1^{st} and 3^{rd} party business income, emergency response, lead, mold, exterior finish & insulating systems, reputational risk, natural resource damage, non-owned disposal sites, merger acquisition and pollution protection coverage, property transfer coverage, surety, excess liability or umbrella coverage, underground and above ground storage tanks, excess of indemnity, or any combinations thereof.

3. The method of claim 1, wherein the HNWI's environmental exposures comprise mold, vandalism, storage, use, and/or maintenance of aircraft, automobile, and watercraft, real estate with historically environmental problems, new construction and remodeling, pollution from neighboring properties, privately owned businesses with environmental exposures, vendors such as contractors (HVAC, electrical, plumbing, painting, septic), domestic help, landscapers/maintenance, pool cleaning/maintenance, caterers, boat captains, aircraft pilots, storm water runoff, vapor intrusion, leaks from elevator hydraulic fluid storage tanks, government reporting requirements, natural resource damages, real estate tenants using or storing environmentally sensitive materials, chemicals, waste, sick building syndrome, above ground or underground storage tanks, adverse reactions and interactions of chemical compounds that accidentally commingle during a fire, farm/garden/lawn fertilizers, herbicides, pesticides, LEEDS, fuel tanks used for backup power generators, asbestos, lead, Brownfields, or any combinations thereof.

4. The method of claim 1, wherein the environmental insurance comprises property transfer coverage, contractors' pollution liability coverage, transportation pollution liability coverage, aviation pollution liability coverage, marine pollution liability coverage, or any combinations thereof.

5. The method of claim 1, wherein analyzing collected data and information regarding the HNWI and the HNWI's resources comprises conducting an environmental efficiency evaluation, wherein the environmental efficiency evaluation categorizes information related to other individuals and business interacting with the HNWI and the HNWI's strategies for handling an environmental loss and compliance with environmental regulations.

6. The method of claim 4, wherein the environmental efficiency evaluation further captures information relating to the types of goods and services exiting the HNWI's business or the HNWI's resources and to environmental liabilities of any neighbors of the HNWI.
